(19) United States
(12) Patent Application Publication
(10) Pub. No.: US 2005/0018006 A1
(43) Pub. Date: Jan. 27, 2005

(54) Method of determining missing nozzles in an inkjet printer

(75) Inventors: Dae-hyeok Im, Gyeonggi-do (KR); Jin-wook Jeong, Gyeonggi-do (KR); Seong-nam Jeon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/875,802

(22) Filed: Jun. 25, 2004

(30) Foreign Application Priority Data
Jun. 27, 2003 (KR) 2003-42791
Oct. 10, 2003 (KR) 2003-70645
Oct. 25, 2003 (KR) 2003-74926

(51) Int. Cl. B41J 29/393

(52) U.S. Cl. 347/19

(57) ABSTRACT

A method of determining missing nozzles in an inkjet printer involving: printing a rectangular test pattern on a printing paper by using each nozzle or each group of nozzles of a printhead, and scanning the rectangular test pattern printed on the printing paper by using an optical sensor, which is an automatic alignment sensor.

### CROSS-REFERENCE TO RELATED APPLICATIONS

This application claims the priority of Korean Patent Applications No. 2003-42791, 2003-74926, and 2003-70645, filed on Jun. 27, 2003, Oct. 25, 2003, and Oct. 10, 2003, respectively, in the Korean Intellectual Property Office, the disclosures of which are incorporated herein by reference.

### BACKGROUND OF THE INVENTION

1. Field of the Invention

The present invention relates to a method of detecting missing nozzles in an inkjet printer, and more particularly, to a method of detecting nozzles in a printhead of an inkjet printer, from which ink is not ejected, by detecting test patterns with the use of an optical sensor.

2. Description of the Related Art

In general, color inkjet printers are loaded with a plurality of ink cartridges, and under the plurality of ink cartridges, a printhead, in which several hundreds of nozzles are formed, is disposed. Some of the nozzles on the printhead may be clogged or may improperly operate due to malfunction of a heater or an actuator connected thereto, or malfunction of a circuit applying power to the heater or the actuator. Nozzles from which ink is not ejected for some reason, are called missing nozzles.

Such missing nozzles leave blanks on a printing medium and reduce the quality of printing. Therefore, it is necessary to print documents without using missing nozzles or to print documents after fixing the missing nozzles.

U.S. Pat. No. 6,215,557 discloses a method and apparatus for identifying faulty inkjet nozzles in an inkjet printer. The disclosed method and apparatus print a test pattern comprised of a plurality of test images in a rectangular grid by ejecting ink droplets from nozzles respectively corresponding to the test images, and identify missing nozzles and print information on the identified missing nozzles by inspecting the printed test pattern using an imaging device and clicking on blank areas on the rectangular grid, on which ink is not ejected, using a pointing device.

The disclosed method and apparatus, however, need an imaging device, and consume a considerable amount of ink to print the plurality of test images on the printing medium. In addition, to detect missing nozzles in an inkjet printer having a plurality of ink cartridges, the disclosed method of identifying faulty inkjet nozzles in an inkjet printer should be performed on each of the ink cartridges, which takes a long time.

FIG. 1 illustrates an apparatus for detecting missing nozzles disclosed in U.S. Pat. No. 6,517,183. Referring to FIG. 1, the apparatus includes a light emitting diode (LED) 1, a photo diode 2, which absorbs light emitted from the LED 1, and an amplifier 3, which amplifies a signal transmitted from the photo diode 2, an analog-to-digital converter 4, which digitalizes a current level output from the amplifier 3, and a detection unit 5, which detects ink droplets by referring to data output from the analog-to-digital converter 4.

If a predetermined nozzle drops ink between the LED 1 and the photo diode 2 while the LED 1 emits a laser beam 10 and the photo diode 2 receives the laser beam from the LED 1, the intensity of the laser beam received from the LED 1 decreases. By detecting the decrease in the intensity of the laser beam received from the LED 1, it is possible to determine whether the predetermined nozzle operates properly. If there is no such decrease in the intensity of the laser beam received from the LED 1, the predetermined nozzle is determined to be clogged.

Even though this type of method of detecting missing nozzles can detect missing nozzles in a tiny place within a very short period of time, it is considered rather inconvenient because of its reliance on very expensive, high-precision equipment.

### SUMMARY OF THE INVENTION

The present invention provides a method of detecting missing nozzles in an inkjet printer by printing a test pattern using a sequence of ink droplets ejected from nozzles of a printhead of the inkjet printer and scanning the test pattern using an automatic alignment optical sensor.

The present invention also provides a method of fixing the missing nozzles.

According to an aspect of the present invention, there is provided a method of determining missing nozzles of a printhead in an inkjet printer by using an optical sensor, the optical sensor being attached to a carriage that moves an ink cartridge attached thereto in a main scanning direction. The method includes (a) dividing nozzles of the printhead in an order of a sub-scanning direction, into n1 groups and printing n1 rectangular test patterns on a printing paper, each test pattern being printed by simultaneously using nozzles of corresponding groups while moving the carriage; (b) scanning the n1 test patterns using the optical sensor and determining whether there is an optical output corresponding to one of the test patterns that is larger than a predetermined threshold value, and (c) if there is an optical output corresponding to one of the test patterns that is larger than the predetermined threshold value, determining missing nozzles among nozzles of a group that printed the test pattern corresponding to the optical output larger than the predetermined threshold.

According to one aspect, a total length of each group of nozzles in the sub-scanning direction is larger than a length of a resolution of the optical sensor.

According to one aspect, said (a) includes (a1) printing parallel lines by simultaneously using nozzles of a first group while moving the carriage in the main scanning direction by a first predetermined length; and (a2) repeatedly performing said (al) using nozzles of following groups in the sub-scanning direction, wherein said (a1) and (a2) are performed in one swath of the carriage in the main scanning direction.

According to one aspect, said (b) includes (b1) scanning a first test pattern; (b2) line-feeding the printing paper in the sub-scanning direction by a second predetermined length; and (b3) detecting a test pattern including missing nozzles by repeatedly performing said (b1) and (b2) for the remaining test patterns.

According to one aspect, said (c) includes (c1) printing parallel lines on the printing paper to have a third predetermined length in the main scanning direction by sequentially using nozzles of the group that printed the test pattern corresponding to the optical output larger than the predetermined threshold, including the missing nozzles; (c2) performing said (c1) after line-feeding the printing paper by a first distance; (c3) repeating said (c2) to form rectangular test patterns, each comprising n2 parallel lines; (c4) scanning a rectangular test pattern by using the optical sensor, and determining a nozzle corresponding to the rectangular test pattern as a missing nozzle if an optical output value of the rectangular test pattern is larger than the predetermined threshold value; (c5) line-feeding the printing paper by the first distance; and (c6) repeatedly performing said (c4) and (c5) on the remaining rectangular test patterns.

According to one aspect, the method further includes (d) spitting the missing nozzles determined in said (c).

According to one aspect, the method further includes wiping the missing nozzles determined in said (c).

According to another aspect of the present invention, there is provided a method of determining missing nozzles of a printhead in an inkjet printer by using an optical sensor, the optical sensor being attached to a carriage that moves an ink cartridge attached thereto in a main scanning direction. The method includes (a) printing parallel lines having a predetermined length in the main scanning direction on a printing paper, by sequentially using nozzles, each parallel line corresponding to a nozzle; (b) performing said (a) after feeding the printing paper by a predetermined distance in a sub-scanning direction; (c) repeating said (b) to form rectangular test patterns, each test pattern corresponding to a nozzle; and (d) scanning each rectangular test pattern by using the optical sensor, and determining a nozzle corresponding to a given rectangular test pattern as a missing nozzle if an optical output value resulting from the scanning of the rectangular test pattern is larger than a predetermined threshold value.

According to one aspect, the rectangular test patterns are printed to be connected to one another on the printing paper.

According to one aspect, a length of the rectangular test patterns in a sub-scanning direction is larger than a length of a resolution of the optical sensor.

According to one aspect, said (d) includes (d1) scanning a first rectangular test pattern; and (d2) scanning a next rectangular test pattern after feeding the printing paper in the sub-scanning direction by the predetermined distance until all rectangular test patterns have been scanned.

According to one aspect, said (d) further includes (d3) determining whether the optical output value resulting from the scanning of the given rectangular test pattern is larger than a first threshold value; (d4) determining the nozzle corresponding to the rectangular test pattern as normally operating if the optical output value resulting from the scanning of the given rectangular test pattern is not larger than the first threshold value; (d5) determining whether the optical output value resulting from the scanning of the given rectangular test pattern is larger than a second threshold value if the optical output value resulting from the scanning of the given rectangular test pattern is larger than the first threshold value; (d6) determining the nozzle corresponding to the given rectangular test pattern as being partially clogged if the optical output value resulting from the scanning of the given rectangular test pattern is lower than the second threshold value; and (d7) determining the nozzle corresponding to the given rectangular test pattern as being completely clogged if the optical output value resulting from the scanning of the first rectangular test pattern is larger than the second threshold value.

According to one aspect, said (a) includes (a1) dividing the nozzles of the printhead into a plurality of consecutive groups disposed in an order of the sub-scanning direction; and (a2) printing the parallel lines having the predetermined length in the main scanning directing by sequentially using nozzles of a selected group, and selecting groups in the order of the sub-scanning direction.

According to one aspect, a length of each rectangular test pattern in the sub-scanning direction is longer than a result of adding a length of the resolution of the optical sensor to a distance between first and last nozzles of each group.

According to one aspect, said (d) includes (d1) scanning the rectangular test patterns; and (d2) determining from the optical value resulting from the scanning output of the given rectangular test pattern, whether there is a rising edge.

According to one aspect, said (d) further includes (d3) determining from the optical output value resulting from the scanning of the given rectangular test pattern, whether there is a falling edge; and (d4) determining a distance between the rising edge and the falling edge, and determining nozzles between the rising edge and the falling edge as being clogged.

According to one aspect, in said (d3), if the falling edge is not detected, nozzles from a nozzle corresponding to the rising edge to a final nozzle in the selected group are determined as missing nozzles.

According to one aspect, in said (d4), the distance between the rising edge and the subsequent falling edge is calculated based on a moving speed of the carriage.

According to one aspect, in said (d4), the distance between the rising edge and the subsequent falling edge is measured by reading marks written on a linear encoder strip using a linear encoder sensor attached to the carriage.

Said (d) further includes (d5) determining whether an optical output value resulting from the scanning of the given rectangular test pattern is larger than a first threshold value; (d6) determining a nozzle corresponding to the given rectangular test pattern as normally operating if the optical output value resulting from the scanning of the given rectangular test pattern is lower than the first threshold value; (d7) determining whether the optical output value resulting from the scanning of the given rectangular test pattern is larger than a second threshold value if it is larger than the first threshold value; (d8) determining the nozzle corresponding to the given rectangular test pattern as being partially clogged if the optical output value resulting from the scanning of the given rectangular test pattern is lower than the second threshold value and larger than the first threshold value; and (d9) determining the nozzle corresponding to the given rectangular test pattern as being completely clogged if the optical output value resulting from the scanning of the given rectangular test pattern is larger than the second threshold value.

According to one aspect, the method further includes (e) spitting the missing nozzle.

According to one aspect, said (e) further includes wiping the missing nozzle.

According to one aspect, said (e) further includes (e1) repeatedly performing said (a) through (d) on the missing nozzles a predetermined number of times; and (e2) reporting the missing nozzles that are determined as missing nozzles after performing said (e1).

Additional aspects and/or advantages of the invention will be set forth in part in the description which follows, and in part, will be obvious from the description, or may be learned by practice of the invention.

### BRIEF DESCRIPTION OF THE DRAWINGS

The above and/or other features and advantages of the present invention will become more apparent by describing in detail exemplary embodiments thereof with reference to the attached drawings in which:

FIG. 1 is a schematic diagram of an apparatus for detecting missing nozzles disclosed in U.S. Pat. No. 6,517,183;

FIG. 2 is a schematic diagram of an inkjet printer, to which a method of detecting missing nozzles in an inkjet printer according to a first embodiment of the present invention is applied;

FIG. 3 is a schematic diagram of an optical sensor of FIG. 2;

FIG. 4 is a diagram illustrating an example of test patterns used in the method of detecting missing nozzles in an inkjet printer according to the first embodiment of the present invention;

FIG. 5 is a schematic diagram of nozzles of a printhead;

FIG. 6 is a diagram illustrating test patterns printed using nozzles N21 through N30 corresponding to a third test pattern T3 of FIG. 4;

FIG. 7 is a flowchart of the method of detecting missing nozzles in an inkjet printer according to the first embodiment of the present invention;

FIG. 8 is a detailed flowchart of operation 210 of FIG. 7;

FIG. 9 is a diagram illustrating a test pattern used in a method of detecting missing nozzles in an inkjet printer according to a second embodiment of the present invention;

FIG. 10 is an enlarged view of the test pattern of FIG. 9;

FIG. 11 is a diagram illustrating the variation of the level of an ink ejection detecting signal depending on a shape of each rectangle of a test pattern;

FIG. 12 is a flowchart of the method of detecting missing nozzles in an inkjet printer according to the second embodiment of the present invention;

FIG. 13 is a detailed flowchart of operation 320 of FIG. 12;

FIG. 14 is a flowchart of a method of detecting missing nozzles in an inkjet printer according to a third embodiment of the present invention;

FIG. 15 is a flowchart of a method of determining a degree of clogging of nozzles according to an embodiment of the present invention; and

FIG. 16 is a flowchart of a method of fixing missing nozzles in an inkjet printer according to an embodiment of the present invention.

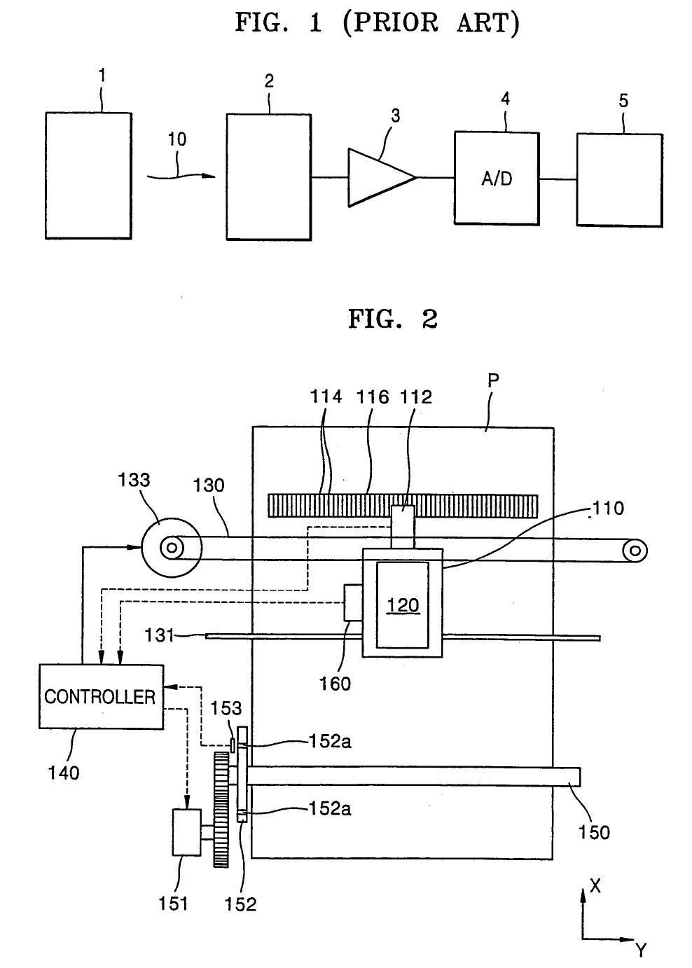

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 2 is a schematic diagram illustrating an inkjet printer, to which a method of detecting missing nozzles in an inkjet printer according to the present invention is applied. Referring to FIG. 2, the inkjet printer includes a carriage 110, which moves over a platen (not shown) in a Y direction that is perpendicular to an X direction, i.e., the X direction is the direction in which a printing paper P on the platen advances. At least one ink cartridge 120 is mounted on the carriage 110. A printhead (not shown), in which a plurality of nozzles (not shown) are formed, is disposed at a bottom of the ink cartridge 120. One end of the carriage 110 is fixably connected to a conveyor belt 130, and the other end of the carriage 110 is connected to a guide rail 131 so that the carriage 110 can slide on the guide rail 131. The carriage 110 is driven to move back and forth in the Y direction by using a motor 133 to drive the conveyor belt 130. A linear encoder sensor 112, which is attached to the carriage 110, reads marks 114 on an encoder strip 116. When the linear encoder sensor 112 rides over the encoder strip 116, the linear encoder sensor 112 generates pulses. A controller 140 precisely controls the movement of the carriage 110 by counting the pulses generated by the linear encoder sensor 112.

An optical sensor 160, which according to one embodiment is an automatic alignment sensor, is attached to the carriage 110 and detects an image printed on the printing paper P placed on the platen. When the optical sensor 160 detects the image, the controller 140 calculates the location of the image in the Y direction using the linear encoder sensor 112.

The printing paper P is moved in the X direction, i.e., a sub scanning direction, by a feeding roller 150. The feeding roller 150 is rolled by a feeding roller driving motor 151. An encoder disk wheel 152 is disposed at one end of the feeding roller 150 along an outer circumference thereof. A rotary encoder sensor 153, which is formed in a main body of the inkjet printer, measures a rotation angle of the encoder disk wheel 152 by generating pulses whenever it encounters slits 152a, which are formed in the encoder disk wheel 152 at regular intervals. The controller 140 controls a rotation distance of the feeding roller 150, i.e., the distance that the printing paper P is fed in the X direction (hereinafter, referred to as feeding distance), by counting the pulses generated by the rotary encoder sensor 153.

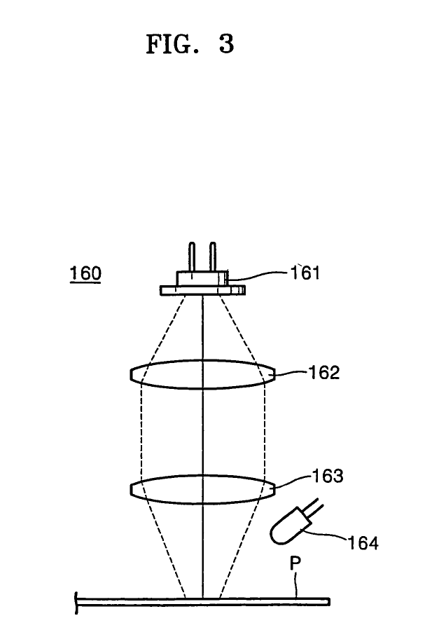

FIG. 3 is a schematic diagram of the optical sensor 160 of FIG. 2. Referring to FIG. 3, the optical sensor 160 includes a light emitting diode (LED) 161, collimating lenses 162 and 163, which collimate light emitted from the LED 161, and a photo diode 164, which receives light reflected from the printing paper P. A light level detected by the photo diode 164 is input to the controller 140 (of FIG. 2), such that the controller 140 determines whether ink was ejected from the nozzles.

The optical sensor 160 that could be economically used in a typical inkjet printer has a resolution of approximately 1/30 inches, and the rotary encoder sensor 153 has a resolution of approximately 1/1200-1/2400 inches, which is higher than that of the optical sensor 160. Therefore, it is difficult to detect a portion on the printing paper P, which is printed with an ink droplet ejected from only one nozzle of an inkjet printer having a printing resolution of 300-600 dpi, by using the optical sensor 160.

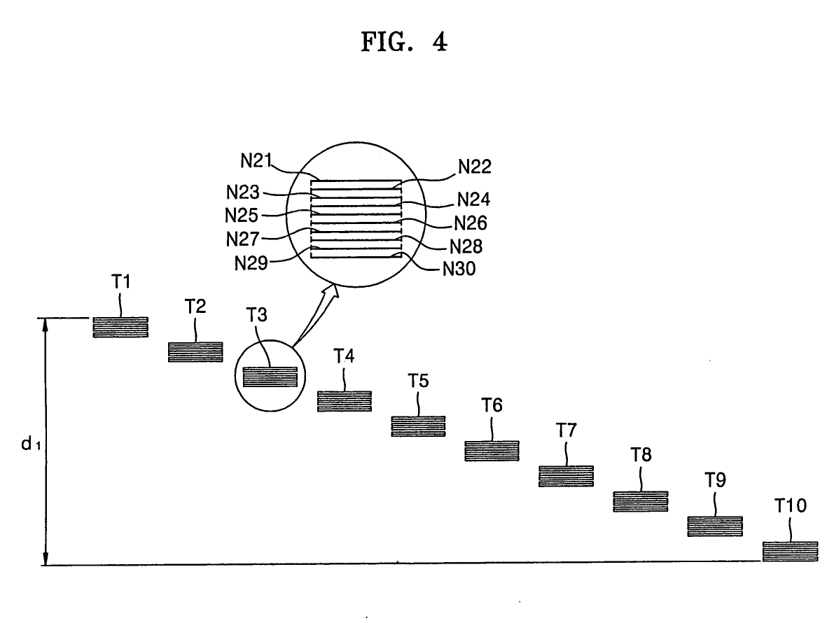

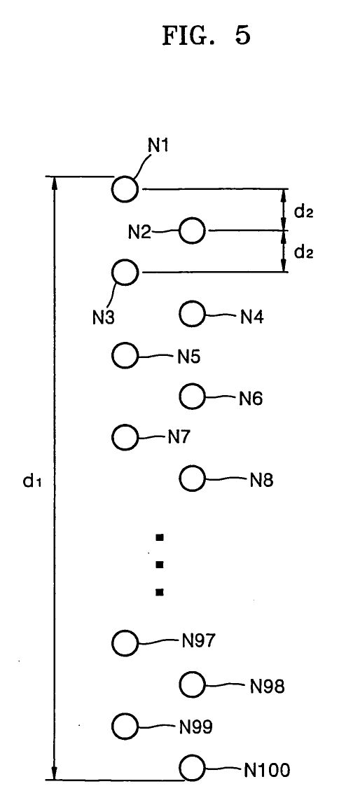

FIG. 4 illustrates first test patterns T1 through T10 used in the method of detecting missing nozzles of an inkjet printer according to the first embodiment, and FIG. 5 illustrates nozzles N1 through N100 of a printhead of the inkjet printer.

Referring to FIG. 5, the nozzles N1 through N100 are arranged in two rows. More specifically, 50 odd-numbered nozzles N1, N3, . . . , N99 are arranged in a first column, and 50 even-numbered nozzles N2, N4, . . . , N100 are arranged in a second column. In FIG. 5, the distance d1 between the first nozzle N1 and the 100-th nozzle N100 is approximately ½ inches, and the distance d₂ between each adjacent nozzles is approximately 1/200.

Referring to FIG. 4, each of the first test patterns T1 through T10 is rectangular. As is shown in an enlarged view of the test pattern T3 of the first test patterns in FIG. 4, each of the first test patterns T1 through T10 comprises 10 parallel lines. The ten parallel lines of each of the first test patterns are printed by ink droplets respectively ejected from every ten consecutive nozzles of the printhead. According to one embodiment, the test patterns T1 through T10 are all printed in one swath by the printhead moving in a main scanning direction. Here, the number of nozzles required to print each of the first patterns is set to 10 based on the assumption that the optical sensor 160 has a resolution of approximately 1/30 inches. In other words, a length of an array of ten consecutive nozzles corresponds to the length of the resolution of the optical sensor 160, i.e., 1/30 inches.

If a signal output from the photo diode 164 when scanning each of the first test patterns T1 through T10 has a higher level than a predetermined threshold value, it is determined that at least one of the parallel lines of the scanned patterns is missing, and that ink was not ejected from a nozzle corresponding to the missing parallel line. According to one embodiment, the printing paper P is fed by 1/30 inches whenever the optical sensor 160 finishes scanning of one of the first test patterns T1 through T10 so that scanning each test pattern is performed under the same condition.

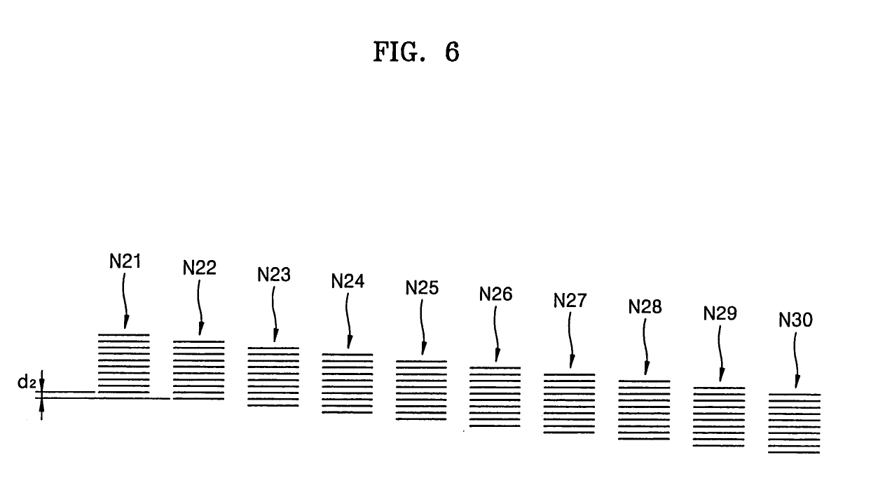

To identify missing nozzles among a set of ten consecutive nozzles of a printhead, second test patterns, which are printed using every ten consecutive nozzles in a manner that is illustrated in FIG. 6, are scanned using the optical sensor 160.

More specifically, referring to FIG. 6, ten second test patterns, each of which is an array of ten parallel lines in a rectangular shape, are respectively printed using, for example, the nozzles N21 through N30, which are used to print the test pattern T3 of the first test patterns of FIG. 4. Each of the second test patterns is printed with ink droplets ejected from one nozzle allotted thereto. Therefore, each of the second test patterns is printed in a manner such that a parallel line is printed, the printing paper P is fed by a predetermined length, and then another parallel line is printed. According to one embodiment, the predetermined length, by which the printing paper P is fed, corresponds to the distance between every two adjacent nozzles, i.e., d₂ of FIG. 5. The number of parallel lines corresponding to one second test pattern is determined based on the resolution of the optical sensor 160. By scanning second test patterns using the optical sensor 160, and detecting signals output from the photo diode 164, it is possible to detect which nozzles are not ejecting ink.

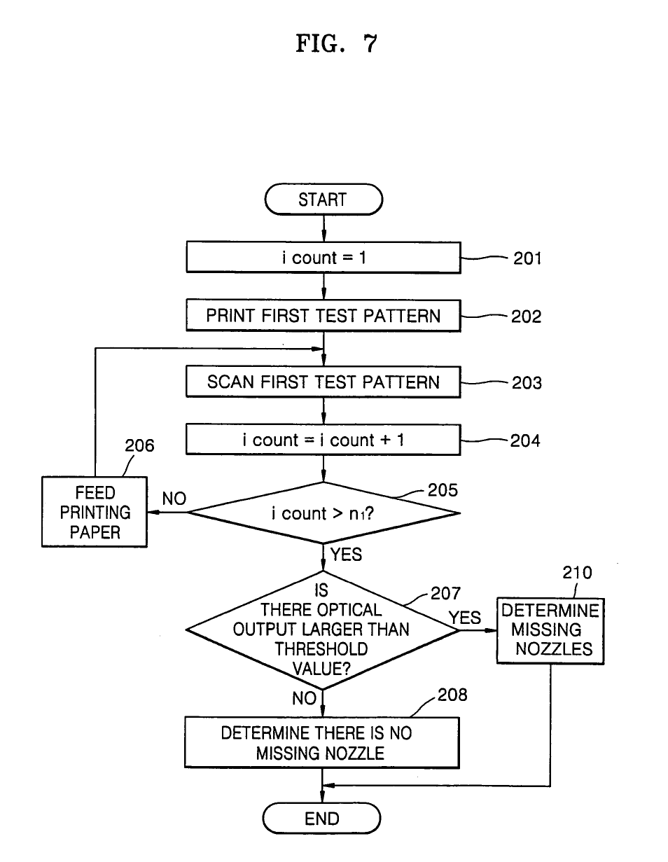

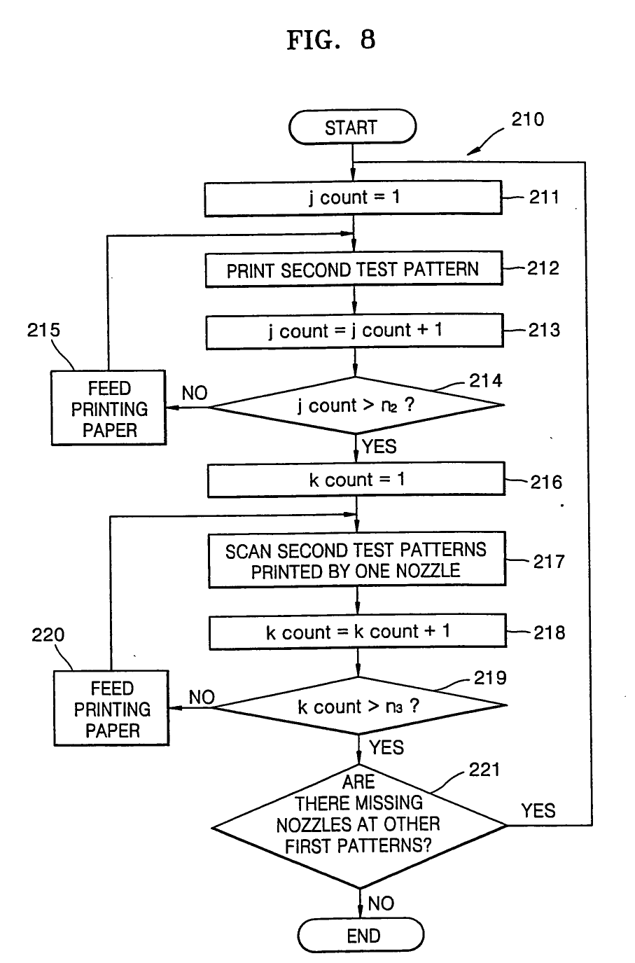

The method of detecting missing nozzles in an inkjet printer according to the first embodiment will now be described with reference to FIG. 7.

FIG. 7 is a flowchart of the method of detecting missing nozzles in an inkjet printer according to the first embodiment. Referring to FIG. 7, a first count value icount is set to 1 in operation 201.

In operation 202, first test patterns, like T1 through T10 of FIG. 4, are all printed on the printing paper P in one swath. Each of the first test patterns is an array of parallel lines respectively printed by a plurality of nozzles. The number of nozzles required to print each of the first test patterns is determined depending on the resolution of an optical sensor 160 and the distance between adjacent nozzles disposed on a printhead. The length of each of the first test patterns in the sub-scanning direction, i.e., the X direction, is preferably larger than the length of the resolution of the optical sensor 160. The first test patterns are printed by one stroke of the carriage 110 that moves in the main scanning direction. The location of each of the first test patterns in the main scanning direction is measured by using the linear encoder sensor 112.

In operation 203, the first test patterns printed on the printing paper P are scanned using the optical sensor 160. The optical sensor 160 outputs a predetermined current level based on results of the scanning, to the controller 140.

In operation 204, the first count value icount is increased by 1. In operation 205, it is determined whether the first count value icount is larger than n1, where n1 represents the number of first test patterns printed on the printing paper P.

In operation 206, if the first count value icount is determined to not be larger than n1 in operation 205, the printing paper P is fed by the length of the first test pattern in the sub-scanning direction, and the method returns to operation 203.

In operation 207, if the first count value icount is determined to not be smaller than n1 in operation 205, the controller 140 determines whether at least one of the current levels output based on the measurements in operation 203 is larger than a predetermined threshold value.

In operation 208, if no one among the current levels output based on the measurements in operation 203 is determined to exceed the predetermined threshold value in operation 207, it is determined that the printhead has no missing nozzles, and the method is completed.

If at least one of the current levels measured in operation 203 is determined to exceed the predetermined threshold value in operation 207, operation 210 is performed to determine missing nozzles.

FIG. 8 is a detailed flowchart of operation 210 of FIG. 7. Referring to FIG. 8, a second count value jcount is set to 1 in operation 211. In operation 212, second test patterns are printed in the manner that is illustrated in FIG. 6. More specifically, the second test patterns are printed by moving the printhead in a first direction and ejecting ink droplets from a group of nozzles (e.g., the nozzles N21 through N30 of FIG. 6) of the printhead. The location of each of the second test patterns printed in operation 212 is measured using the linear encoder sensor 112.

In operation 213, the second count value jcount is increased by 1. In operation 214, it is determined whether the second count value jcount is larger than n2, where n2 represents the number of parallel lines of each of the second test patterns printed in operation 211, for example, 10.

If the second count value jcount is determined to not be larger than n2 in operation 214, the printing paper P is fed by a predetermined distance, for example, d₂ of FIG. 6, in operation 215, and the method returns to operation 212.

If the second count value jcount is determined to be larger than n2 in operation 214, a third count value kcount is set to 1 in operation 216.

In operation 217, the first one of the second test patterns, which is printed by the first nozzle (e.g., N21 of FIG. 6) of ten consecutive nozzles of the printhead, is scanned using the optical sensor 160. The optical sensor 160 outputs a predetermined current level based on the scanning result. If the predetermined current level is higher than the predetermined threshold value, the controller 140 determines that ink has not been ejected from the first nozzle (e.g., N21 of FIG. 6) of ten consecutive nozzles of the printhead. Otherwise, the controller 140 determines that the first nozzle (e.g. N21) is working properly.

In operation 218, the third count value kcount is increased by 1. In operation 219, it is determined whether the third count value kcount is larger than n3, where n3 represents the number of nozzles that are used to print the second test patterns in operation 212.

If the third count value kcount is determined to not be larger than n3 in operation 219, the printing paper P is fed by 1/200 inches in operation 220, and the method returns to operation 217.

In operation 221, if the third count value kcount is determined to be larger than n3 in operation 219, it is determined whether there are other first test patterns, from which missing nozzles are detected.

If it is determined in operation 221 that there are other first test patterns, from which missing nozzles are detected, the method returns to operation 211.

If it is determined in operation 221 that there are no other first test patterns from which missing nozzles are detected, the method is completed.

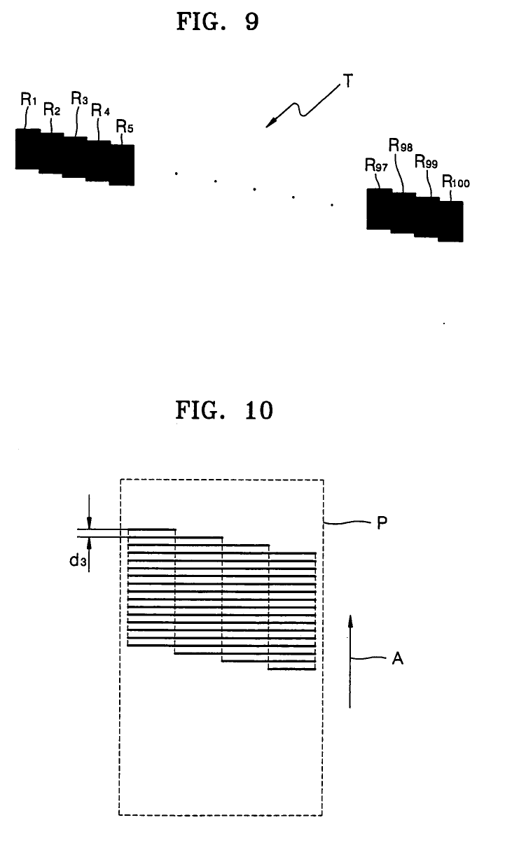

FIG. 9 illustrates a test pattern T used in a method of detecting missing nozzles in an inkjet printer according to a second embodiment of the present invention, and FIG. 10 is an enlarged view of the test pattern T of FIG. 9.

Referring to FIG. 9, the test pattern T is comprised of an array of identical rectangles R1 through R100 connected to one another in a main scanning direction. The rectangles R1 through R100 are printed by the nozzles N1 through N100, respectively, of FIG. 5.

Referring to FIG. 10, each of the rectangles R1 through R100 is comprised of an array of parallel lines, which are printed in the main scanning direction to have a predetermined length by a corresponding nozzle repeatedly in the sub scanning direction. Since the nozzles N1 through N100 are sequentially arranged in the sub-scanning direction, the array of the rectangles R1 through R100 are printed in the main scanning direction to form a predetermined angle with the main scanning direction. Therefore, the test pattern T is formed in a manner such that the first parallel line of each of the rectangles R1 through R100 is printed with one stroke of the carriage 110 that moves in the main scanning direction, the sheet of printing paper P is fed in the sub-scanning direction by a predetermined distance d3 using the feeding roller 150, and the second parallel line of each of the rectangles R1 through R100 is printed with another stroke of the carriage 110 that moves in the main scanning direction. According to one embodiment, the number of parallel lines comprising each of the rectangles R1 through R100 is set to 16 based on the resolution of the optical sensor 160, which is approximately 1/30 inches. In other words, the length of each of the rectangles R1 through R100 in the sub-scanning direction is calculated by multiplying the predetermined distance d3, by which the feeding roller 150 incrementally travels, by the number of parallel lines comprising each of the rectangles R1 through R100 (i.e., 16). And thus, the test pattern T is formed so that each side of each of the rectangles R1 through R100 is larger than the length of the resolution of the optical sensor 160, which is approximately 1/30 inches. Therefore, the optical sensor 160 can scan each and every one of the rectangles R1 through R100.

If a signal output from the photo diode 164 during scanning the test pattern T using the optical sensor 160 has a higher level than the predetermined threshold value, it is determined that ink has not been ejected from a nozzle corresponding to a rectangle of the test pattern T. According to one embodiment, to scan the rectangles R1 through R100 under the same conditions, the optical sensor 160 is set to detect and scan the first rectangle R1, feed the printing paper P by a predetermined distance, and then scan the second rectangle R2.

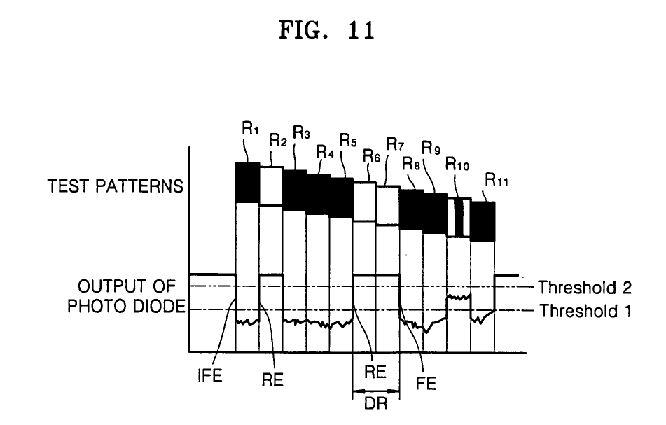

FIG. 11 is a diagram illustrating a variation of the level of an ink ejection detecting signal depending on the shape of each rectangle of a test pattern. Referring to FIG. 11, the optical sensor 160 scans each rectangle of the test pattern in a main scanning direction. If a rectangle of the test pattern corresponding to a nozzle is properly printed on the printing paper P, a signal output from the photo diode 164 as a result of scanning the rectangle has a low current level. If ink has not been ejected from the predetermined nozzle, the signal output from the photo diode 164 has a high current level. The signal output from the photo diode 164 has a higher current level in a case where the predetermined nozzle is partially clogged than in a case where the predetermined nozzle is not clogged.

According to one embodiment, it is assumed that a first threshold value Threshold 1 is set as a criterion for determining whether each nozzle is clogged. Since a signal output from the photo diode 164 of a tenth rectangle R10 has a higher current level than the first threshold value Threshold 1, a tenth nozzle corresponding to the tenth rectangle R10 is determined to be open. However, in the case of setting a second threshold value Threshold 2 as the criterion for determining whether each nozzle is clogged, the tenth nozzle is determined as improperly working because the signal output from the photo diode 164 has a lower current level than the second threshold value Threshold 2. Therefore, it may be differently determined whether ink has been ejected from the tenth nozzle depending on which threshold value is set as the criterion for determining whether each nozzle is clogged. According to one embodiment, if the signal output from the photo diode 164 has a current level between the first and second threshold values Thresholds 1 and 2, the tenth nozzle is determined to be partially clogged. In a case where the tenth nozzle is determined to be partially clogged, the ink cartridge 120 is moved to a service station disposed at one side of an inkjet printer, and then the tenth nozzle can be normally operated by spitting the corresponding nozzle.

According to one embodiment, the linear encoder sensor 112 detects the location of missing nozzles by measuring a distance DR between a rising edge RE and a falling edge FE of the signal output from the photo diode 164, as is shown in FIG. 11. According to one embodiment, the distance between the rising edge RE and the falling edge FE is calculated based on a moving speed of the carriage. Additionally, according to one embodiment, if no initial falling edge (IFE) is detected, it is determined that all nozzles are missing nozzles. Similarly, if after an initial falling edge is detected, no subsequent rising edge is detected, it is determined that there are no missing nozzles. Further, if the initial falling edge is detected to correspond to a nozzle other than the first nozzle, then all nozzles from the first nozzle until the nozzle corresponding to the initial falling edge are determined to be missing nozzles.

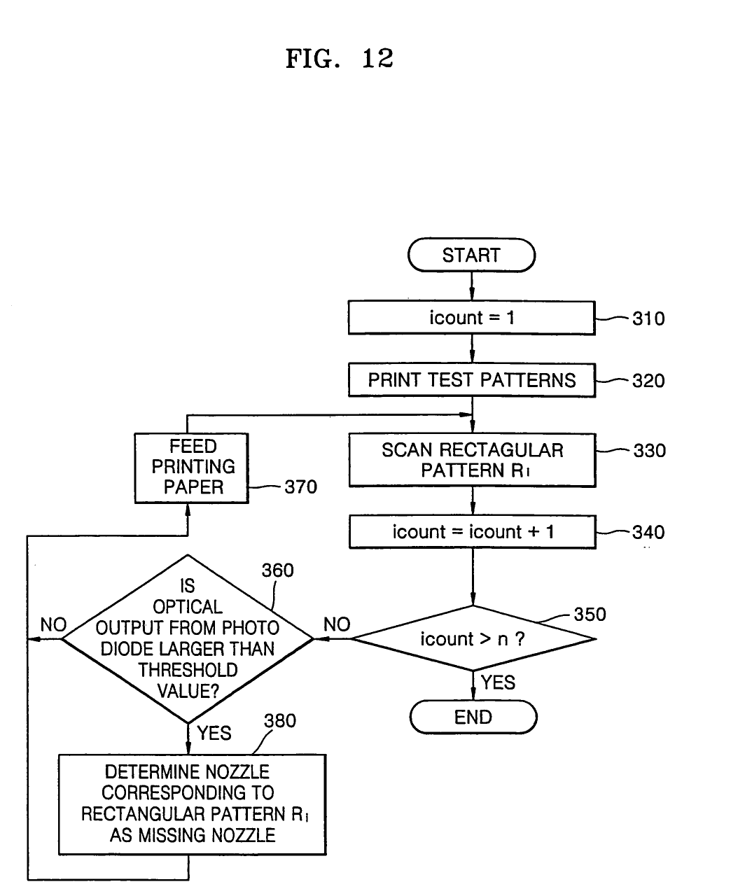

FIG. 12 is a flowchart of the method of detecting missing nozzles in the inkjet printer according to the second embodiment. Referring to FIG. 12, the first count value icount is set to 1 in operation 310. In operation 320, the test pattern, which, like the test pattern T of FIG. 9, is comprised of a plurality of rectangles, is printed.

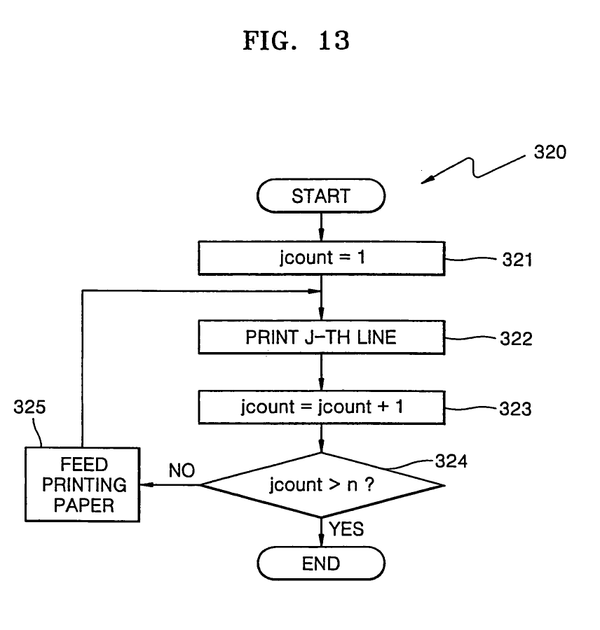

FIG. 13 is a detailed flowchart of operation 320 of FIG. 12. Referring to FIG. 13, the second count value jcount is set to 1 in operation 321.

In operation 322, a parallel line of each of the rectangles are printed to have a predetermined length by ejecting ink droplets from a corresponding nozzle while moving the ink cartridge 120 in the main scanning direction with the use of the carriage 110. During moving the ink cartridge 120 in the main scanning direction, the location of each parallel line is controlled using the linear encoder sensor 112.

In operation 323, the second count value jcount is increased by 1. In operation 324, it is determined whether the second count value jcount is larger than n5, where n5 represents the number of parallel lines of each of the rectangles printed by one nozzle. As is shown in FIG. 10, n5 may be set to, for example, sixteen, in consideration of the resolution of the optical sensor 160.

In operation 324, if the second count value jcount is determined to not be larger than n5 in operation 324, the feeding roller 150 is driven to move by d₃ of FIG. 10 (in operation 325) so that the printing paper P can be fed, and the method returns to operation 322.

In operation 324, if the second count value jcount is determined to be larger than n5, operation 320 is complete.

Referring to FIG. 12 again, the first rectangle of the test pattern printed by the first nozzle of the printhead is scanned using the optical sensor 160 in operation 330. The optical sensor 160 transmits a current level output from the photo diode 164 as the scanning result to the controller 140.

In operation 340, the first count value icount is increased by 1. In operation 350, it is determined whether the first count value is larger than n4. According to one embodiment, n4 represents the number of nozzles used to print the test pattern.

In operation 350, if the first count value icount is determined to not be larger than n4, it is determined whether the current level output from the photo diode 164 in operation 330 is higher than the predetermined threshold value (in operation 360).

In operation 360, if the current level output is determined to not be larger than the predetermined threshold value, the feeding roller 150 is driven to move by d₃ of FIG. 10 (in operation 370) so that the printing paper can be fed, and the method returns to operation 330.

In operation 360, if the current level output is determined to be higher than the predetermined threshold value, it is determined that ink has not been ejected from the corresponding nozzle of the printhead (operation 380), and operation 370 is performed.

In operation 350, if the first count value icount is determined to be larger than n4, the entire process of detecting missing nozzles is completed.

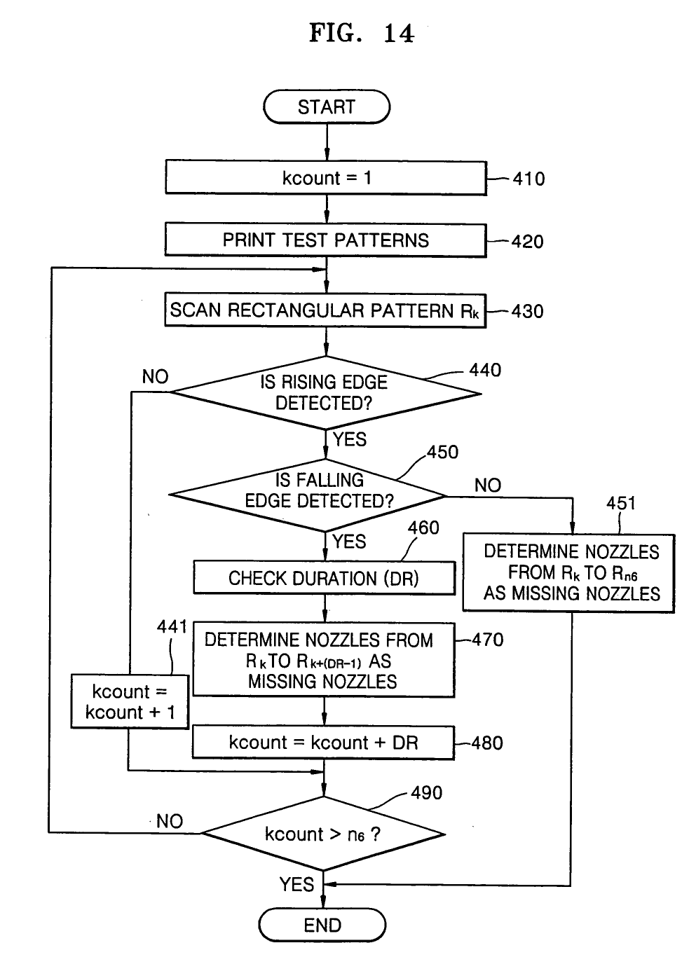

FIG. 14 is a flowchart of a method of detecting missing nozzles in the inkjet printer according to a third embodiment of the present invention. Referring to FIG. 14, the third count value kcount is set to 1 in operation 410.

In operation 420, a test pattern, which, like the test pattern T of FIG. 9, is comprised of a plurality of rectangles, is printed. Nozzles of a printhead disposed at the ink cartridge 120 are successively divided into a plurality of groups in a sub scanning direction, and the rectangles of the test pattern are respectively printed using a selected group of nozzles in the same manner that is used in step 320 of FIG. 12. For example, the nozzles N1 through N100 of FIG. 5 may be classified into four groups ranging from the first nozzle N1 to the twenty fifth nozzle, from the twenty sixth nozzle to the fiftieth nozzle, from the fifty first nozzle to the seventy fifth nozzle, and from the seventy sixth nozzle to the hundredth nozzle, respectively. Each of the nozzles of the selected groups prints one of the rectangles of the test pattern, as is shown in FIG. 9. A number n6 of nozzles of each group is determined so that the length of the rectangles of the test pattern in the sub scanning direction is larger than a result of adding the length of the resolution of the optical sensor 160 to the distance between the first and last nozzles of each of the groups. According to one embodiment, the test pattern is scanned by one stroke of the optical sensor 160 that moves in the main scanning direction. Operation 420 is very similar to operation 320 of FIG. 13, and thus a detailed description will be omitted.

In operation 430, the K^{th} rectangle of the test pattern, which is printed on the printing paper P by the K^{th} nozzle N_{K}, is scanned using the optical sensor 160. The optical sensor 160 transmits a current level output from the photo diode 164 to the controller 140.

In operation 440, it is determined whether a rising edge is detected from the current level output. In operation 450, if a rising edge is detected from the current level output in operation 440, it is determined whether a falling edge is detected from the current level output.

In operation 460, a distance DR (i.e., a scanning duration) between the rising and falling edges detected from the current level output and the number of nozzles that fall therebetween are calculated, if a falling edge is detected from the current level output in operation 450. In operation 470, it is determined that ink has not been ejected from k-th through (k+DR−1)-th nozzles.

In operation 480, the third count value kcount is increased by DR.

In operation 490, it is determined whether the third count value kcount is larger than n6, which according to one embodiment, represents the number of nozzles used to print the rectangles of the test pattern.

If the third count value kcount is determined to not be larger than n6 in operation 490, the method returns to operation 430. Otherwise, the entire process of detecting missing nozzles is completed.

If a falling edge is not detected from the current level output in operation 450, it is determined that ink has not been ejected from the k-th through n6-th nozzles (operation 451).

If a rising edge is not detected from the current level output in operation 440, the third count value kcount is increased by 1 (operation 441), and operation 490 is performed.

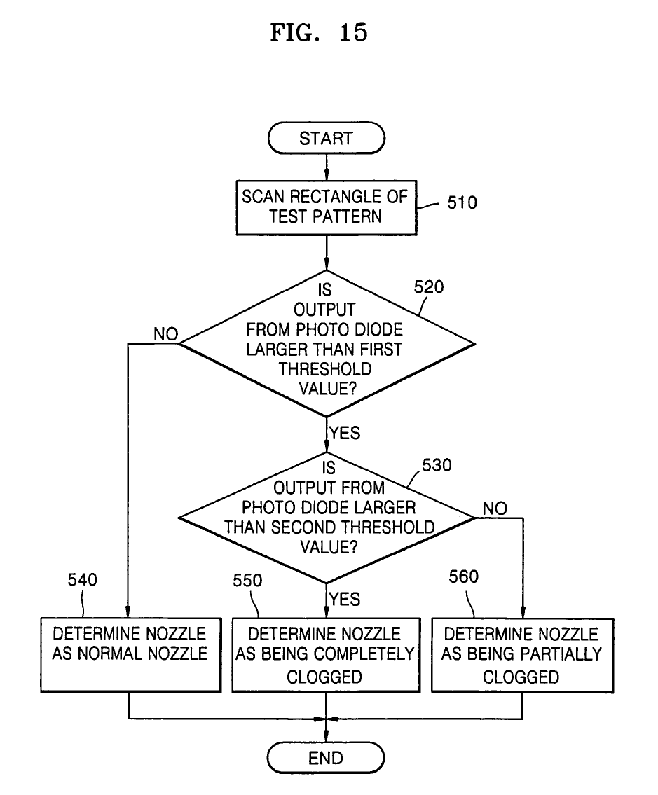

FIG. 15 is a flowchart of a method of determining the degree to which a nozzle is clogged, which is used in a method of detecting missing nozzles in an inkjet printer according to an embodiment of the present invention. Referring to FIG. 15, a predetermined rectangle of a test pattern printed by a particular nozzle is scanned operation 510.

In operation 520, it is determined whether a current level output from the photo diode 164 as the scanning result is higher than a first threshold value (i.e., Threshold 1 of FIG. 11).

If the current level output is determined to be higher than the first threshold value in operation 520, it is determined whether the current level output is higher than a second threshold value (i.e., Threshold 2 of FIG. 11) (operation 530).

If the current level output is determined to be higher than the second threshold value in operation 530, a nozzle corresponding to the predetermined rectangle is determined to be completely clogged (operation 550) and the method is completed.

If the current level output is determined to not be higher than the second threshold value in operation 530, the nozzle is determined to be partially clogged (operation 560) and the method is completed.

If the current level output is determined to not be higher than the first threshold value in operation 520, the nozzle is determined to operate normally (operation 540) and the method is completed. According to one embodiment, this method is performed for each nozzle.

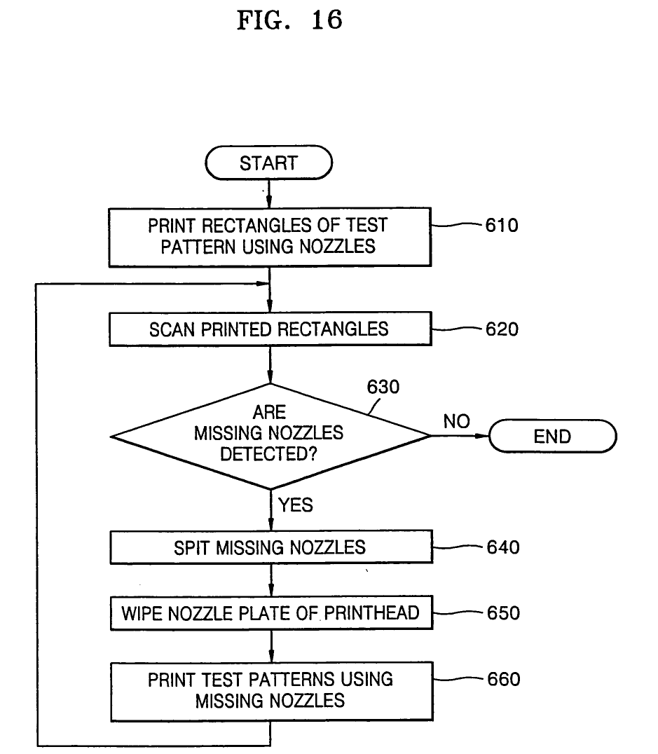

FIG. 16 is a flowchart of a method of correcting missing nozzles in an inkjet printer according to an embodiment of the present invention. Referring to FIG. 16, rectangles of a test pattern are respectively printed on the printing paper P using nozzles of a printhead (operation 610).

In operation 620, the rectangles printed on the printing paper P are sequentially scanned using the optical sensor 160.

If current levels output from the photo diode 164 as results of scanning the rectangles in operation 620 are determined to be higher than a predetermined threshold value, corresponding nozzles are designated as missing nozzles, and serial numbers thereof are stored (operation 630).

If it is determined that no missing nozzle is detected in operation 630, the corresponding nozzles are determined to normally operate, and the process of detecting missing nozzles is completed.

If it is determined that there are missing nozzles in operation 630, the cartridge 110 is moved to a service station disposed at one side of an inkjet printer, and an ink-spitting process is performed on the missing nozzles (operation 640) so that ink or dirt clogging the missing nozzle can be spitted out.

In operation 650, the cartridge 110 is moved to a printing section, and a nozzle plate of the printhead is wiped (operation 650) so that dust that may be clogging the missing nozzles can be removed.

In operation 660, a test pattern having discrete areas corresponding to each missing nozzle is printed using the missing nozzles, the locations of which were stored in operation 630, and the method returns to operation 620.

Even though the method of correcting missing nozzles in an inkjet printer according to this embodiment of the present invention is illustrated in FIG. 16 as if it is repeatedly performed until no missing nozzle is detected, it may be completed after being performed 2-3 times (operations 630 through 660 of FIG. 16 have been described above as being repeatedly performed until no missing nozzle is detected, they may be performed only 2-3 times, thereby completing the entire process of correcting missing nozzles). According to one embodiment, the method of correcting missing nozzles further comprises notifying a user of detected missing nozzles.

The methods of detecting missing nozzles may be applied to a color inkjet printer having a plurality of ink cartridges as well as an ink printer having a single ink cartridge.

As is described above, it is possible to automatically detect missing nozzles of a printhead by using an optical sensor that is an automatic alignment sensor having low resolution, correct the missing nozzles through ink-spitting and wiping processes, and check whether the corrected nozzles normally operate.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of determining missing nozzles of a printhead in an inkjet printer by using an optical sensor, the optical sensor being attached to a carriage that moves an ink cartridge attached thereto in a main scanning direction, the method comprising:
(a) dividing nozzles of the printhead in an order of a sub-scanning direction, into n1 groups and printing n1 rectangular test patterns on a printing paper, each test pattern being printed by simultaneously using nozzles of corresponding groups while moving the carriage;
(b) scanning the n1 test patterns using the optical sensor and determining whether there is an optical output corresponding to one of the test patterns that is larger than a predetermined threshold value, and
(c) if there is an optical output corresponding to one of the test patterns that is larger than the predetermined threshold value, determining missing nozzles among nozzles of a group that printed the test pattern corresponding to the optical output larger than the predetermined threshold.

2. The method of claim 1, wherein a total length of each group of nozzles in the sub-scanning direction is larger than a length of a resolution of the optical sensor.

3. The method of claim 1, wherein said (a) comprises:
(a1) printing parallel lines by simultaneously using nozzles of a first group while moving the carriage in the main scanning direction by a first predetermined length; and
(a2) repeatedly performing said (a1) using nozzles of following groups in the sub-scanning direction,
wherein said (a1) and (a2) are performed in one swath of the carriage in the main scanning direction.

4. The method of claim 3, wherein said (b) comprises:
(b1) scanning a first test pattern;
(b2) line-feeding the printing paper in the sub-scanning direction by a second predetermined length; and
(b3) detecting a test pattern including missing nozzles by repeatedly performing said
(b1) and (b2) for the remaining test patterns.

5. The method of claim 4, wherein said (c) comprises:
(c1) printing parallel lines on the printing paper to have a third predetermined length in the main scanning direction by sequentially using nozzles of the group that printed the test pattern corresponding to the optical output larger than the predetermined threshold, including the missing nozzles;
(c2) performing said (c1) after feeding the printing paper by a first distance;
(c3) repeating said (c2) to form rectangular test patterns, each comprising n2 parallel lines;
(c4) scanning a rectangular test pattern by using the optical sensor, and determining a nozzle corresponding to the rectangular test pattern as a missing nozzle if an optical output value of the rectangular test pattern is larger than the predetermined threshold value;
(c5) line-feeding the printing paper by the first distance; and
(c6) repeatedly performing said (c4) and said (c5) on the remaining rectangular test patterns.

6. The method of claim 1 further comprising:
(d) spitting the missing nozzles determined in said (c).

7. The method of claim 6 further comprising:
wiping the missing nozzles determined in said (c).

8. A method of determining missing nozzles of a printhead in an inkjet printer by using an optical sensor, the optical sensor being attached to a carriage that moves an ink cartridge attached thereto in a main scanning direction, the method comprising:
(a) printing parallel lines having a predetermined length in the main scanning direction on a printing paper, by sequentially using nozzles, each parallel line corresponding to one of the nozzles;
(b) performing said (a) after feeding the printing paper by a predetermined distance in a sub-scanning direction;
(c) repeating said (b) to form rectangular test patterns, each test pattern corresponding to one of the nozzles; and
(d) scanning each rectangular test pattern by using the optical sensor, and determining a nozzle corresponding to a given rectangular test pattern as a missing nozzle if an optical output value resulting from the scanning of the rectangular test pattern is larger than a predetermined threshold value.

9. The method of claim 8, wherein the rectangular test patterns are printed to be connected to one another on the printing paper.

10. The method of claim 8, wherein a length of the rectangular test patterns in the sub-scanning direction is larger than a length of a resolution of the optical sensor.

11. The method of claim 8, wherein said (d) comprises:
(d1) scanning a first rectangular test pattern; and
(d2) scanning a next rectangular test pattern after feeding the printing paper in the sub-scanning direction by the predetermined distance until all rectangular test patterns have been scanned.

12. The method of claim 11, wherein said (d) further comprises:
(d3) determining whether the optical output value resulting from the scanning of the given rectangular test pattern is larger than a first threshold value;
(d4) determining the nozzle corresponding to the given rectangular test pattern as normally operating if the optical output value resulting from the scanning of the given rectangular test pattern is not larger than the first threshold value;
(d5) determining whether the optical output value resulting from the scanning of the given rectangular test pattern is larger than a second threshold value if the optical output value resulting from the scanning of the given rectangular test pattern is larger than the first threshold value;
(d6) determining the nozzle corresponding to the given rectangular test pattern as being partially clogged if the optical output value resulting from the scanning of the given rectangular test pattern is lower than the second threshold value; and
(d7) determining the nozzle corresponding to the given rectangular test pattern as being completely clogged if the optical output value resulting from the scanning of the first rectangular test pattern is larger than the second threshold value.

13. The method of claim 8, wherein said (a) comprises:
(a1) dividing the nozzles of the printhead into a plurality of consecutive groups disposed in an order of the sub-scanning direction; and
(a2) printing the parallel lines having the predetermined length in the main scanning directing by sequentially using nozzles of a selected group, and selecting groups in the order of the sub-scanning direction.

14. The method of claim 13, wherein a length of each rectangular test pattern in the sub-scanning direction is longer than a result of adding a length of resolution of the optical sensor to a distance between first and last nozzles of each group.

15. The method of claim 8, wherein said (d) comprises:
(d1) scanning the rectangular test patterns; and
(d2) detecting, from the optical output value resulting from the scanning of the given rectangular test pattern, whether there is an initial falling edge, and whether there is a rising edge subsequent to the initial falling edge,
wherein if no rising edge subsequent to the initial falling edge is detected, it is determined that there are no missing nozzles, and
if no initial falling edge is detected, determining that all nozzles are missing nozzles.

16. The method of claim 15, wherein said (d) further comprises:
(d3) detecting, from the optical output value resulting from the scanning of the given rectangular test pattern, whether there is a falling edge subsequent to the rising edge; and
(d4) if the falling edge subsequent to the rising edge is detected, determining a distance between the rising edge and the subsequent falling edge, and determining nozzles between the rising edge and the subsequent falling edge as being clogged.

17. The method of claim 16, wherein in said (d3), if the falling edge is not detected subsequent to detection of the rising edge, nozzles from a nozzle corresponding to the rising edge to a final nozzle in the selected group are determined as missing nozzles.

18. The method of claim 16, wherein in said (d4), the distance between the rising edge and the subsequent falling edge is calculated based on a moving speed of the carriage.

19. The method of claim 16, wherein in said (d4), the distance between the rising edge and the subsequent falling edge is measured by reading marks written on a linear encoder strip using a linear encoder sensor attached to the carriage.

20. The method of claim 17, wherein said (d) further comprises:
(d5) determining whether an optical output value resulting from the scanning of a given rectangular test pattern is larger than a first threshold value;
(d6) determining a nozzle corresponding to the given rectangular test pattern as normally operating if the optical output value resulting from the scanning of the given rectangular test pattern is lower than the first threshold value;
(d7) determining whether the optical output value resulting from the scanning of the given rectangular test pattern is larger than a second threshold value if the optical output value resulting from the scanning of the given rectangular test pattern is larger than the first threshold value;
(d8) determining the nozzle corresponding to the given rectangular test pattern as being partially clogged if the optical output value resulting from the scanning of the given rectangular test pattern is lower than the second threshold value and larger than the first threshold value; and
(d9) determining the nozzle corresponding to the given rectangular test pattern as being completely clogged if the optical output value resulting from the scanning of the given rectangular test pattern is larger than the second threshold value.

21. The method of claim 8, further comprising:
(e) spitting the missing nozzle.

22. The method of claim 21, wherein said (e) further comprises;
(e1) wiping the missing nozzle.

23. The method of claim 21, wherein said (e) further comprises:
(e1) repeatedly performing said (a) through (d) on the missing nozzles a predetermined number of times; and
(e2) reporting the missing nozzles that are determined as missing nozzles after performing said (e1).
